(19) United States
(12) Patent Application Publication
(10) Pub. No.: US 2011/0073189 A1
(43) Pub. Date: Mar. 31, 2011

(54) WATER SHUT OFF WITH FLOW SENSOR EMERGENCY SHUT DOWN

(76) Inventors: James C. Elbert, Acworth, GA (US); Gregory P. Kendall, Canton, GA (US)

(21) Appl. No.: 12/895,329

(22) Filed: Sep. 30, 2010

Related U.S. Application Data
(60) Provisional application No. 61/247,174, filed on Sep. 30, 2009.

(51) Int. Cl. F16K 31/02

(52) U.S. Cl. 137/1; 137/487.5

(57) ABSTRACT

An apparatus and method for monitoring and shutting off water flow through a conduit in which a user sets a time period for which water may flow through the apparatus. Once the time limit has been reached, the apparatus of the invention shuts a valve, ceasing water flow to a water-using appliance.

### REFERENCE TO OTHER APPLICATIONS

This application is related and claims priority to the U.S. provisional patent application Ser. No. 61/247,174, filed Sep. 30, 2009.

### BACKGROUND OF THE INVENTION

1. Field of the Technology

This invention relates, generally, to the field of after-market water shut-off valves and more specifically to valves that include a water flow sensor and a shut-off valve that operates based on a user-set timer.

2. Background

Leaking water can ruin flooring, electrical systems, furniture, or any other contents of a dwelling or other building. A severe leak or uninterrupted and uncontained water flow may also cause significant and costly damage to the structure of a home or dwelling by spreading beyond the immediate area of the leak or onto another floor of the building. In addition to damage and expenses resulting from leaks or flooding, water-using appliances such as toilets, ice-makers, or leaky faucets or pipes can quickly raise a water bill if allowed to run too long before shutting off. Such excessive running is also detrimental to the environment by wasting water. Areas that are especially prone to drought or where water resources are short cannot afford water wasted in inefficient appliances.

Prior art after-market, consumer-installed, water shut-off mechanisms such as the “Water Cop” have multiple problems. Some require placement of sensors on the floor or low along a wall in rooms near water-using appliances, near pipes, or wherever a user believes there may be a risk of a leak. When water leaks and begins to flood a room, the water trips the sensors, which signal a main controller. The controller then closes the valve. Shut-off occurs too late with this type of mechanism because when the sensors are tripped, water has already been leaking enough to cause damage.

The prior art Automatic Fluid Flow Sensor And Fluid Shut-Off System described in U.S. Pat. No. 5,004,014 to Bender (“Bender”) describes a water flow sensor and shut-off valve attached in line with the main water source for a building. The apparatus and system described in Bender has multiple problems. First, it requires constant power from the standard 120V power source of the building to keep the valve located between the main water source and the building or dwelling open and supplying water for normal usage. If the building or dwelling loses power, the valve between the main water source could close, depriving the building or dwelling of water. In an emergency situation in which power is lost for days, the building or dwelling could also lose water for an equal amount of time, possibly creating a dangerous or deadly situation.

An additional problem with Bender is its infrared emitter and detector flow sensor, which also requires a constant power source. Finally, the Bender system also presents the problem that it may only be controlled and reset from its location outside of the dwelling or building. There is no means for dynamic control from inside the building or dwelling or a way to adjust the timer real-time.

### SUMMARY

An embodiment of the present invention is a water shut-off system that monitors water flow, allows water flow through a pipe for a selected period of time, and shuts off water flow after the selected period of time has elapsed. An embodiment of such a system may be comprised of a pipe through which water is allowed to flow, a flow sensor to monitor the water flow, a timer to monitor the duration of the water flow, and a shut-off valve to stop the water flow. Such a system may be installed after-market by the home or building owner and may operate dynamically real-time, allowing the user to determine and set how long water is allowed to flow before the shut-off mechanism operates. Embodiments of such an apparatus may be used on an individual appliance in or to the main water valve for the home. Such an apparatus may be independently powered, such as by a battery, or powered via a standard, 120-Volt electrical system or by other voltages. A battery may be the primary power source or may be a back-up if a main power source to the unit fails.

An embodiment of the present invention, described in more detail below, provides an apparatus that may be placed on the water line between the shut-off valve and an appliance, between a shut off valve and a branch line, or between the main water supply for a building and the main shut off valve. Such a unit, in accordance with an embodiment of the invention may have a flow sensor to detect water flowing through a pipe and have a timer mechanism. The timer will be set by a user, such that water flow will be stopped by the apparatus after the duration of time set by the user. The device may function such that the water flow will be stopped before a leak can cause additional damage.

An embodiment of the invention comprises a water flow shut-off apparatus, comprising: a conduit to accommodate water flow; a passive water flow sensor; a time delay timer capable of communicating with said passive water flow sensor; an electric motor capable of communicating with said time delay timer; and a spherical ball valve connected to said electric motor and sized such that it fills the interior circumference of said conduit.

An additional embodiment of the invention further comprises a power source adapter capable of accepting at least one battery as a power source.

An additional embodiment of the invention further comprises a power source adapter comprised of an AC to DC power transformer.

An additional embodiment of the invention further comprises a reset mechanism capable of communicating with said electric motor.

An additional embodiment of the invention further comprises a trip and disengagement mechanism capable of communicating with said electric motor.

An additional embodiment of the invention further comprises a timer selector capable of communicating with said time delay timer.

An additional embodiment of the invention further comprises timer selector providing the time period from which said time delay timer counts down.

An additional embodiment of the invention further comprises a control panel in communication with said apparatus via a communications link.

An additional embodiment of the invention further comprises a control panel is detached from said apparatus.

An additional embodiment of the invention further comprises a central processing unit for: monitoring said passive water flow sensor; accessing and communicating with said time delay timer; providing instructions to said electric motor; and accepting instructions from said reset mechanism, said trip and disengagement mechanism, or from said control panel.

An additional embodiment of the invention further comprises a method for shutting off water flow, comprising providing a water shut-off apparatus that accomplishes the steps of: setting an acceptable time limit for a water flow through a conduit; monitoring said water flow through said conduit; timing the duration of said water flow; determining whether said duration of said water flow through said comment is within said acceptable time limit; and closing a water flow valve when said acceptable time limit is reached.

An additional embodiment of the invention further comprises providing a power source for said water shut-off apparatus.

An additional embodiment of the invention further comprises a power source comprising an apparatus capable of accepting a battery.

An additional embodiment of the invention further comprises a power source comprising an AC to DC power transformer.

An additional embodiment of the invention further comprises resetting said water flow valve after said acceptable time limit has been reached.

An additional embodiment of the invention further comprises providing a control panel located separately from said water shut-off apparatus.

### BRIEF DESCRIPTION OF THE DRAWINGS

FIG. 1 shows a top-view and possible controls of an embodiment of the apparatus of the invention.

FIG. 2 shows a representation of the electronics provided in the interior of an apparatus.

FIG. 3 shows a schematic of a possible control circuit of an embodiment of the invention.

FIG. 4 shows a cut-away schematic of the internal components of an embodiment of the present invention and a logically connected control panel.

### DETAILED DESCRIPTION OF EXEMPLARY EMBODIMENTS

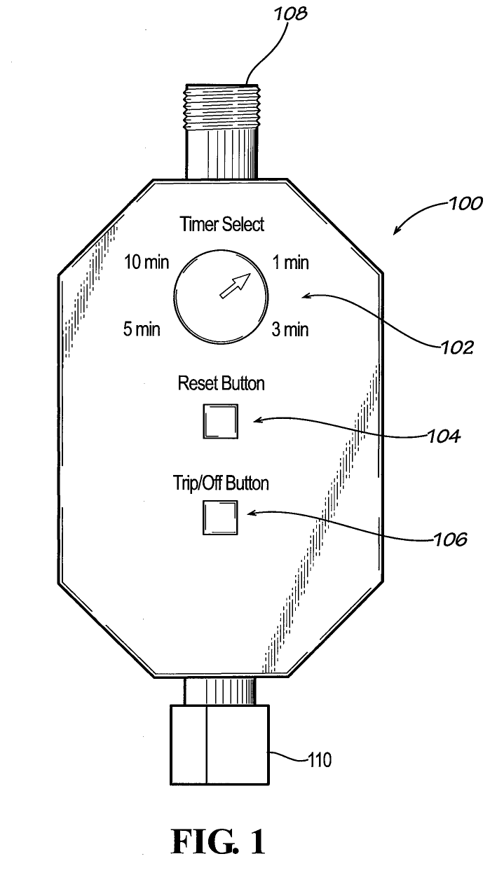

Turning now to the drawings, where like numbers represent like description, herein, FIG. 1 is a top view of an embodiment of the water flow shut off apparatus 100 of the invention. A timer selector 102 is provided such that the user may select how long the water may flow through the apparatus once water flow is detected. As shown, the user may select a water flow of 1 minute, 3 minutes, 5 minutes, or 10 minutes, depending on where the unit is attached, whether it is attached to a single appliance, to a particular section of pipes, or to the main water source. It is understood that the selection will be determined based on a water use occasion, which is based on location of the apparatus. After the selected duration, water flow will be shut off. It will be understood by one of ordinary skill in the art that these time periods are for explanatory purposes only and not meant as limitations. It will also be understood by one of ordinary skill in the art that different units may be manufactured with options for more varied time periods, depending on whether they are to restrict water flow to a particular appliance, a section of a building or home, or to the main water source.

An embodiment of the present invention may also include a reset button 104 on the face of the exterior casing of the apparatus 100 shown in FIG. 1. After the water shut-off has been tripped and the embodiment of the invention activated, the user can reset the unit without removing it from service. Once the problem is resolved, the user can then reset the unit, returning it to normal operation and returning water flow to the appliance, home or building, or portion thereof. Also provided is a test-off button 106, which allows the user to disable the unit if necessary.

FIG. 1 also shows how the embodiment of the invention 100 is connected between the water supply and the appliance. A threaded, male end 108 attaches to the supply line of the water-using appliance or to the main water supply. A female end 110 is connected to the water supply line after the shut off valve to the appliance. It will be understood by one of ordinary skill in the art that an embodiment of the invention may be similarly attached the main water supply before the main shut-off valve for the dwelling or building or to a particular branch of the plumbing system. Where the apparatus is employed is left to the discretion of the owner of the dwelling or building and those of ordinary skill in the art. It will be further appreciated by one of ordinary skill in the art that an embodiment may be installed to shut off the main water supply. It will be further understood by those of ordinary skill in the art that multiple embodiments may be used in a building or dwelling whether on individual appliances or on branches of a water system. Those of ordinary skill in the art will also appreciate that each embodiment will be sized as necessary for its particular use with the appropriate sized valve to accommodate the water pressures experienced by each usage.

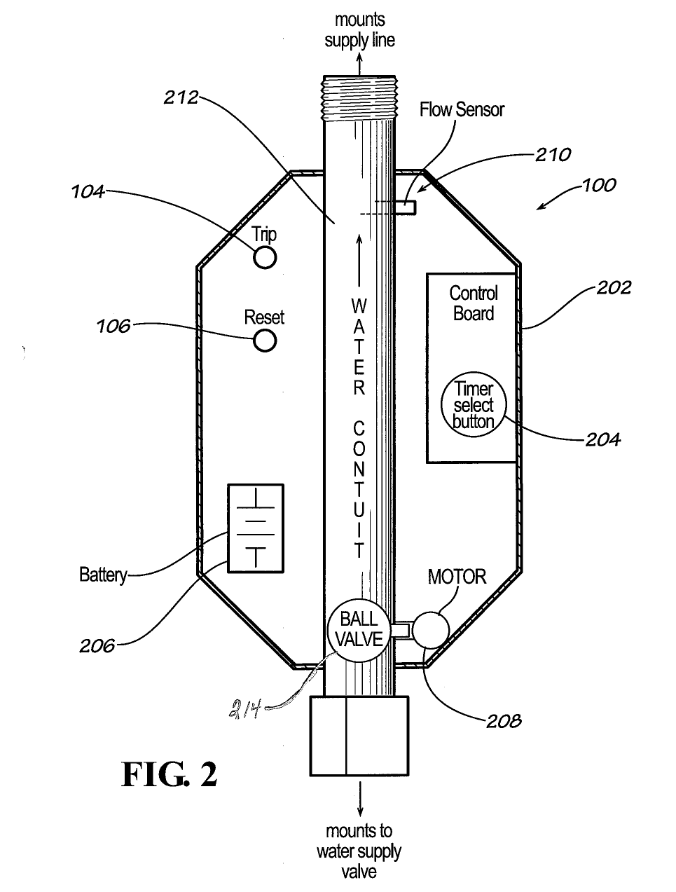

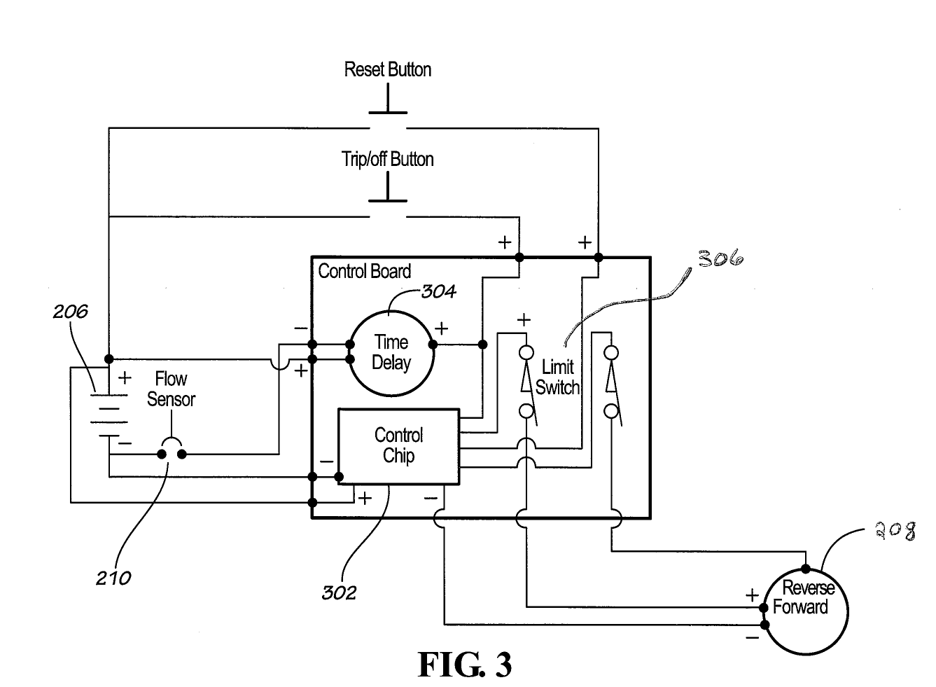

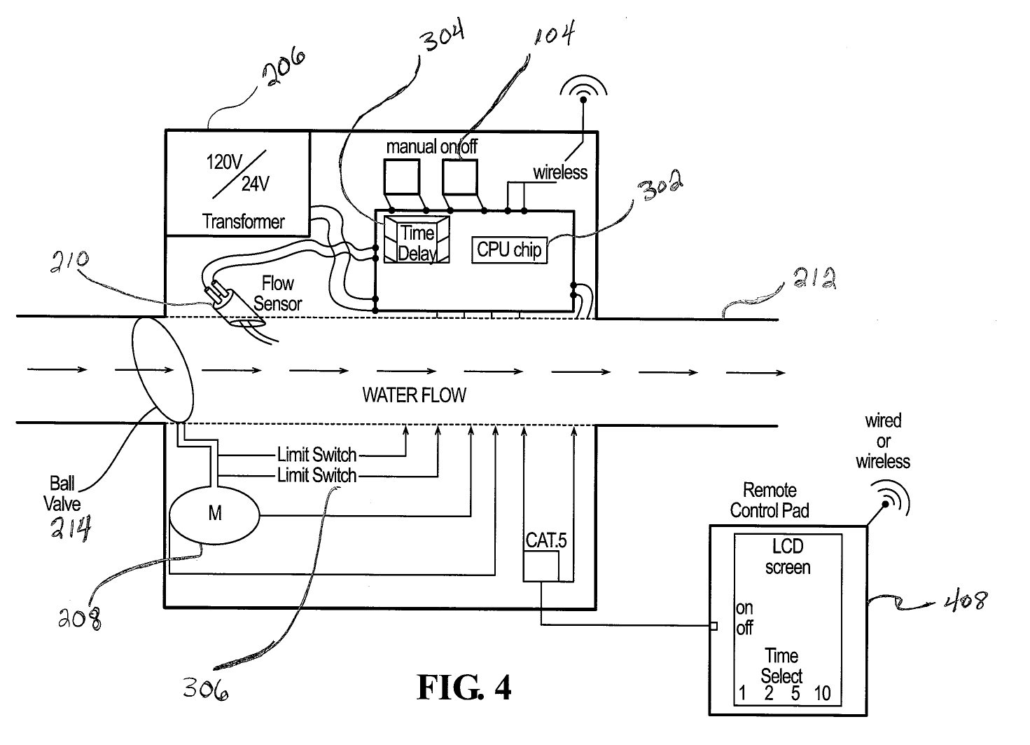

Referring now to FIG. 2, which shows a representation of the electronics and other hardware provided in the interior of an apparatus 100, which is an embodiment of the present invention. The reset 106 and test-off 104 buttons are shown on the interior of the apparatus 100. Also shown is the control board 202, a representative circuit for which is shown in further detail in FIG. 3, which includes a timer select interface 204 for the timer select switch 102. The timer select interface 204 translates the timer selector switch 102 setting to data to be used by the apparatus to determine the duration that water is allowed to flow through it, as is further described with respect to FIG. 4. Additionally included is a power source 206 to power the motor assembly 208 and the flow sensor 210. It will be understood by one of ordinary skill in the art that an embodiment of the unit may be powered by a battery or by a building or home 120V electrical source or other voltage source, such as 24V or any other standard battery or power supply voltage. It will be further understood that the power source 206 may be a transformer to work with a particular voltage or a battery and transformer combination, such that a battery unit may serve as a back up when the power supply fails. Additionally, in embodiments powered by a battery only, when the battery power drops to a level such that it may no longer power the apparatus, the valve will close, thereby notifying the user that the battery should be replaced.

An embodiment of the invention 100 functions such that water flows from the water source to the appliance through the water conduit 212. When the appliance operates, water flows from the valve supply through the water conduit 212, thereby triggering the flow sensor 210 on its way to the appliance. Based on the type of appliance, its needed water usage, and the possibility of leaking or flooding, the user has present the timer selector 102 to a certain amount of time that it will allow water to flow through the conduit 212. If the predetermined time that was selected by the user is reached, then the motor 208 is activated to close the ball valve 214. The ball valve 214 is essentially a hollow sphere that has openings disposed on its shell and aligned in such a way that when in the “open” position, water is allowed to flow through the valve and along the length of the conduit 212. When signaled, as discussed with respect to FIG. 4, the motor 208 then turns the ball valve 214 such that the solid shell of the sphere is aligned along the length of the conduit 212, thereby preventing further water flow.

Turning now to FIG. 3, a schematic of the control circuit of an embodiment of the invention is provided. A control chip 302 is provided to monitor and control the components of the circuit and the apparatus. It will be understood by those of ordinary skill in the art that a simple integrated circuit control chip that may communicate with and signal the various components of the apparatus may be used. When the water begins flowing through the conduit 212, it trips the flow sensor 210, which closes the circuit and begins the time delay clock timer 304, as further described with respect to FIG. 4. It will be understood by one of ordinary skill in the art that the time delay clock timer 304 within the circuit tracks the amount of time elapsed while water flows through the conduit 212. The time delay clock timer 304 is connected to the timer select switch 102 via the timer select interface 204. The motor 208 connected to the ball valve 214, powered by the battery 206 or other power supply, ceases turning the ball valve 214 when the limit switch 306 closes, cutting the operation of the motor.

FIG. 4 is a combination logical and physical layout diagram of an embodiment of the apparatus 100 of the invention discussed above. The CPU integrated circuit control chip 302 contains the hardware and firmware necessary to control and monitor the unit. The CPU control chip 302 also contains the time delay timer 304. The flow sensor 210 is attached to the conduit 212 through with the water flows in such a way that the sensing mechanism is inside the conduit 212 and the connections to the CPU control chip 302 are outside the conduit 212, and the conduit 212 is sealed so as not to allow water to leak from the conduit 212 into the electronic components of the unit. One of ordinary skill in the art will understand that the flow sensor 210 is substantially a passive device. Although multiple types of a flow sensor may function properly, a passive flow sensor 210 such as that it is only activated when water flows past its receptors. Exemplary flow sensors that may be used in the embodiment of the invention include a Gems Sensors and Controls RFS and Flow Rate Monitoring-RFA Types; a Kobold Instruments PSR-OEM Paddle flow switch; and Hunter Irrigation Innovators Flow-Clik sensors. It will be understood by one of ordinary skill in the art that these are examples of types of flow sensors that may be used, but other sensors with similar functionalities may be used and are not meant as limitations.

At that time, the flow sensor 210 sends a signal to the CPU control chip 302, which starts the time delay timer 304, which monitors how long the water flows through the conduit 212. As described above, the time delay timer 304 counts down the time period selected by the user. If the water flow through the conduit ceases before the countdown completes, the CPU control chip 302 resets the time delay timer 304 for the next occurrence. Should the countdown complete before the water flow ceases, the CPU control chip 302 signals the motor 208 to operate, and it turns the ball valve 214 substantially ninety degrees in order to block the flow of water. The limit switch 306, as will be understood by one of ordinary skill in the art, will be tuned such that it allows power to pass to the motor 208 only long enough for the motor to close the valve. Once the valve is closed, the limit switch 306 cuts the power to the motor. When the user determines that the occurrence is over and/or it is safe to open the valve, again, he or she depresses the “Reset” button 104, and the process reverses itself, reopening the valve and allowing water flow to resume.

FIG. 4 also shows a 120V/24V transformer 206. As described above, this is the power source for the unit and, as is understood by one of ordinary skill in the art, may be a battery, a battery back up, or a transformer for various voltage sources. This representation is for exemplary purposes, only, and is not meant as a limitation.

FIG. 4 also shows a control panel 408 connected to the unit by wireless communication or by a cable capable of carrying information signals such as Category 5 telecommunications cable. Such a control pad will consist of an LCD screen and electronics and will be capable of being located wherever is desired in the dwelling or building. Such a control pad may control a main unit or multiple units throughout a dwelling or building.

In view of the foregoing, it will be appreciated that an embodiment of the present invention can be connected between a water valve and a water-using appliance, between a water source and a branch of a water usage area of a dwelling of a building, or at between a main water source and the main shut-off valve for a dwelling or other building. An exemplary embodiment may be powered by a battery on board the unit or by connection to a building power source. One of ordinary skill in the art will understand that the unit may operate from varying voltage sources, and each unit will be designed for a particular operational voltage. The time delay clock counts down the elapsed time of water flow through the conduit. When the elapsed water flow time reaches the time limit set by the user, the check valve ceases to operate and closes the valve. Water flow through the conduit then ceases.

It will be understood by one of ordinary skill in the art that the above description is of an exemplary embodiment of the invention and is not meant for purposes of limitation. The present invention may be used with multiple voltages, either battery powered or through building electrical current. It may be attached to a main mater line or between a water line and a water-using appliance. An apparatus of the present invention monitors the time water flows through the apparatus and closes the valve to prevent water flow when the set time limit is reached.

What is claimed is:

1. A water flow shut-off apparatus, comprising:
a conduit to accommodate water flow;
a passive water flow sensor;
a time delay timer capable of communicating with said passive water flow sensor;
an electric motor capable of communicating with said time delay timer; and
a spherical ball valve connected to said electric motor and sized such that it fills the interior circumference of said conduit.

2. The water flow shut-off apparatus of claim 1, further comprising a power source adapter capable of accepting at least one battery as a power source.

3. The water flow shut-off apparatus of claim 1, further comprising a power source adapter comprised of an AC to DC power transformer.

4. The water flow shut-off apparatus of claim 1, further comprising a reset mechanism capable of communicating with said electric motor.

5. The water flow shut-off apparatus of claim 1, further comprising a trip and disengagement mechanism capable of communicating with said electric motor.

6. The water flow shut-off apparatus of claim 1, further comprising a timer selector capable of communicating with said time delay timer.

7. The water flow shut-off apparatus of claim 6, wherein said timer selector provides the time period from which said time delay timer counts down.

8. The water flow shut-off apparatus of claim 1, further comprising a control panel in communication with said apparatus via a communications link.

9. The water flow shut-off apparatus of claim 8, wherein said control panel is detached from said apparatus.

10. The water flow shut-off apparatus of claim 8, further comprising a central processing unit for:
monitoring said passive water flow sensor;
accessing and communicating with said time delay timer;
providing instructions to said electric motor; and accepting instructions from said
reset mechanism, said trip and disengagement mechanism, or from said control panel.

11. A method for shutting off water flow, comprising providing a water shut-off apparatus that accomplishes the steps of:
setting an acceptable time limit for a water flow through a conduit;
monitoring said water flow through said conduit;
timing the duration of said water flow;
determining whether said duration of said water flow through said comment is within said acceptable time limit; and
closing a water flow valve when said acceptable time limit is reached.

12. The water flow shut-off method of claim 1, further comprising providing a power source for said water shut-off apparatus.

13. The water flow shut-off method of claim 12, wherein said power source comprises an apparatus capable of accepting a battery.

14. The water flow shut-off method of claim 12, wherein said power source comprises an AC to DC power transformer.

15. The water flow shut-off method of claim 1, further comprising resetting said water flow valve after said acceptable time limit has been reached.

16. The water flow shut-off method of claim 1, further comprising providing a control panel located separately from said water shut-off apparatus.
